(19) United States
(12) Patent Application Publication
(10) Pub. No.: US 2017/0320051 A1
(43) Pub. Date: Nov. 9, 2017

(54) POROUS SILICA AND CHROMATOGRAPHIC CARRIER

(71) Applicant: AGC SI-TECH CO., LTD., KITAKYUSHU-SHI (JP)

(72) Inventors: YOUICHI KAYANO, KITAKYUSHU-SHI (JP); RYOU NAKASHIMA, KITAKYUSHU-SHI (JP); HIROYOSHI MIYAHARA, KITAKYUSHU-SHI (JP)

(73) Assignee: AGC SI-TECH CO., LTD., KITAKYUSHU-SHI (JP)

(21) Appl. No.: 15/658,587

(22) Filed: Jul. 25, 2017

Related U.S. Application Data
(63) Continuation of application No. PCT/JP2016/061444, filed on Apr. 7, 2016.

(30) Foreign Application Priority Data
Apr. 10, 2015 (JP) 2015-080705

(51) Int. Cl. B01J 39/17; B01J 39/26; B01J 39/18; B01J 20/281; B01J 39/04

(52) U.S. Cl. CPC B01J 39/17; G01N 30/482; B01J 39/04; B01J 39/18; B01J 39/26

(57) ABSTRACT

To provide a porous silica having high alkali resistance; and a chromatographic carrier using such a porous silica. A porous silica comprising a phosphorus oxide component and a zirconium oxide component, wherein the amount of phosphorus atoms per unit specific surface area of the porous silica is from 1 μmol/m² to 25 μmol/m²; and the amount of zirconium atoms per unit specific surface area of the porous silica is from 1 μmol/m² to 15 μmol/m². And, a chromatographic carrier which contains a ligand immobilized to such a porous silica.

### TECHNICAL FIELD

The present invention relates to a porous silica, a chromatographic carrier, and a method for producing a porous silica.

### BACKGROUND ART

A porous silica may be used as a filler for liquid chromatography, a carrier for immobilized enzyme, a shape selective catalyst, a material for adsorption or separation of various ions, a delustering agent for coating material, a cosmetic raw material, etc.

In a case where a porous silica is used in an alkaline environment depending on the application of the porous silica, it is desired to use one having alkali resistance imparted to the porous silica.

In recent years, in the pharmaceutical field and medical field, it has become important to purify or remove a specific protein with high accuracy by using affinity chromatography. For example, in the case of purifying a chemical having a specific function, it is required to purify a specific protein with high accuracy.

In affinity chromatography, as a ligand, protein A having a specific binding property is widely used. Protein A is a protein derived from eubacterium Staphylococcus aureus (Staphylococcus) being gram-positive coccus, and has a nature to specifically bind to an Fc region of IgG derived from various animals, and thus, it is widely used in IgG purification. A technique is widely known in which protein A is immobilized to an insoluble carrier, and by affinity chromatography using such an insoluble carrier, IgG is specifically separated and purified.

In an affinity carrier to be used in affinity chromatography, usually, a structure called a linker is interposed between the insoluble carrier and the ligand, and one end of the linker is bound to the carrier, and the other end of the linker is bound to the ligand, thereby to immobilize the ligand to the insoluble carrier (Patent Document 1).

In affinity chromatography, the carrier may be subjected to alkali washing, and therefore, alkali-resistance of the carrier becomes important.

One method of imparting alkali resistance to a porous silica is disclosed in Patent Document 2 and Patent Document 3.

Patent Document 2 proposes a method for producing a silica gel excellent in alkali resistance, by letting a zirconium component be supported on the silica gel.

Patent Document 3 discloses a separating agent having protein A immobilized to controlled pore glass coated with zirconia.

### PRIOR ART DOCUMENTS

### Patent Documents

Patent Document 1: WO2013/062105

Patent Document 2: Japanese Patent No. 2740810

Patent Document 3: WO2014/067605

### DISCLOSURE OF INVENTION

### Technical Problems

In Patent Documents 2 and 3, alkali resistance is imparted to a porous silica by treating it with zirconia, but no study has been made on the pore shape of the porous silica after the treatment. Further, it is desirable to further improve alkali resistance of the porous silica.

On the other hand, in a case where a porous silica is to be used as a chromatographic carrier, it is desired to maintain the pore shape of the porous silica as between before and after treatment with the zirconia, and to keep the number of theoretical plates of the porous silica high after the treatment.

An object of the present invention is to provide a porous silica having high alkali-resistance, and a chromatographic carrier using such a porous silica.

### Solution to Problems

The present invention is each of the following inventions.
[1] A porous silica comprising a phosphorus oxide component and a zirconium oxide component, wherein the amount of phosphorus atoms per unit specific surface area of the porous silica is from 1 μmol/m² to 25 μmol/m², and the amount of zirconium atoms per unit specific surface area of the porous silica is from 1 μmol/m² to 15 μmol/m².
[2] A porous silica for chromatographic carrier, made of the porous silica as defined in the above [1].
[3] The porous silica according to [2], wherein the number of theoretical plates obtainable by the following calculating formula from a peak detected by measurement of standard polystyrene with a molecular weight of 453 using a column packed with the porous silica, is at least 2,000 plates,

N=5.54×[t/W_{0.5}]²

where N is the number of theoretical plates, t is the retention time of the component, and W_{0.5} is the peak width at 50% position of the peak height.
[4] A chromatographic carrier comprising the porous silica as defined in the above [1], and a ligand immobilized to the porous silica.
[5] The chromatographic carrier according to [4], which is a chromatographic carrier for affinity chromatography, and the ligand contains protein A.
[6] The chromatographic carrier according to [5], wherein the immobilized amount of protein A is at least 9.5 mg/mL-bed.
[7] The chromatographic carrier according to [4] or [5], wherein the dynamic binding capacity is at least 35 mg/mL-bed.
[8] The chromatographic carrier according to [4], which is a chromatographic carrier for cation exchange chromatography wherein said ligand contains a sulfonic acid or carboxy group, a chromatographic carrier for anion exchange chromatography wherein said ligand contains an amine, a chromatographic carrier for reverse phase chromatography wherein the ligand contains an alkyl group, or a chromatographic carrier for size exclusion chromatography wherein the ligand contains a diol group.
[9] A method for producing a porous silica, which comprises attaching a phosphorus oxide precursor and a zirconium oxide precursor in an optional order or simultaneously to a porous silica, followed by calcining.
[10] The method for producing a porous silica according to [9], wherein the amount of phosphorus atoms per unit specific surface area of the obtainable porous silica is from 1 μmol/m² to 25 μmol/m², and the amount of zirconium atoms per unit specific surface area of the porous silica is from 1 μmol/m² to 15 μmol/m².
[11] The method for producing a porous silica according to [9] or [10], wherein the phosphorus oxide precursor is attached to the porous silica, and then the zirconium oxide precursor is attached to the porous silica.
[12] The method for producing a porous silica according to any one of [9] to [11], wherein the phosphorus oxide precursor is phosphorus oxychloride, phosphoryl ethanolamine, potassium dihydrogen phosphate, dipotassium hydrogen phosphate, sodium dihydrogen phosphate, disodium hydrogen phosphate, a trialkyl phosphine, a triphenyl phosphine, a trialkyl phosphine oxide, a triphenyl phosphine oxide, a phosphoric acid ester, polyphosphoric acid or its salt, orthophosphoric acid or its salt, or phosphorus pentoxide.
[13] The method for producing a porous silica according to any one of [9] to [12], wherein the zirconium oxide precursor is zirconium (IV) chloride, zirconium (III) chloride, zirconium oxychloride, a tetraalkoxy zirconium, or a dialkoxy zirconium dichloride.
[14] The method for producing a porous silica according to any one of [9] to [13], wherein the phosphorus oxide precursor and the zirconium oxide precursor are attached to the porous silica by a dry method.
[15] The method for producing a porous silica according to any one of [9] to [14], wherein the temperature for the calcining is from 300° C. to 500° C.

Further, the present invention provides the following invention.
[16] A method for conducting chromatography by using the chromatographic carrier as defined in the above [4].
[17] A method for producing a protein, which comprises purifying a protein by using the chromatographic carrier as defined in the above [4].
[18] The method for producing a protein according to [17], wherein the protein is IgG.
[19] An affinity chromatographic carrier, which is an affinity chromatographic carrier having protein A immobilized, wherein the dynamic binding capacity is at least 35 mg/mL-bed, and when immersed in a 500 mM aqueous sodium hydroxide solution at room temperature for 20 hours, the proportion of the dynamic binding capacity after the immersion is at least 60% to the dynamic binding capacity before the immersion.

### Advantageous Effects of Invention

According to the present invention, it is possible to provide a porous silica having high alkali resistance and a chromatographic carrier using the same.

### BRIEF DESCRIPTION OF DRAWINGS

FIG. 1 is a graph showing the relation of the number of theoretical plates to the polystyrene molecular weight.

FIG. 2 is a graph showing the relative Si elution amount in each Example.

FIG. 3 is a graph showing the relation of the relative Si elution amount to the amount of the phosphorus oxide precursor.

FIG. 4 is a graph showing the relation of the relative Si elution amount to the amount of the zirconia oxide precursor.

### DESCRIPTION OF EMBODIMENTS

Now, the present invention will be described, but it should be understood that the present invention is not limited by exemplifications in the following description.

The porous silica of the present invention is a porous silica comprising a phosphorus oxide component and a zirconium oxide component, characterized in that the amount of phosphorus atoms per unit specific surface area of the porous silica is from 1 μmol/m² to 25 μmol/m², and the amount of zirconium atoms per unit specific surface area of the porous silica is from 1 μmol/m² to 15 μmol/m². Hereinafter, the porous silica of the present invention will also be referred to as “porous silica (A)”.

According to the present invention, it is possible to provide a porous silica having high alkali resistance. Further, by using the porous silica (A), it is possible to provide a chromatographic carrier having high alkali resistance.

Further, by using the porous silica (A), it is possible to keep the number of theoretical plates of the chromatographic carrier high.

By using the chromatographic carrier having high alkali resistance and a high number of theoretical plates, it is possible to provide a chromatographic carrier having high separating ability even in an alkaline state. Further, in the case of subjecting the chromatography carrier to alkaline cleaning, it is possible to prevent lowering of the number of theoretical plates by repeated use.

At least a part of zirconium oxide contained in the porous silica (A) is considered to be bound to the silica by a bond represented by Si—O—Zr. Hereinafter, the zirconium oxide component contained in the porous silica (A) will also be referred to as “Zr component”. Further, in the present invention, a zirconium oxide precursor is a zirconium compound to be converted to the oxide by e.g. calcining. Hereinafter, the “zirconium oxide precursor” will also be referred to as “precursor Zr.”

Similarly, at least a part of the phosphorus oxide contained in the porous silica is considered to be bound to the silica by a bond represented by Si—O—P. In addition, at least a part of the phosphorus oxide is believed to be bound further to the zirconia by a bond represented by Zr—O—P. Hereinafter, the phosphorus oxide component contained in the porous silica (A) will also be referred to as “P component”. Further, in the present invention, the phosphorus oxide precursor is preferably a phosphorus compound to be converted to the oxide by e.g. calcining. Hereinafter, the “phosphorus compound precursor” will also be referred to as “precursor P”.

By treating the porous silica with precursor Zr, it is possible to impart alkali resistance, but on the other hand, it has been found that the pore shape changes. It is considered that probably at the time of treating the porous silica with precursor Zr, distribution of Zr component on the porous silica surface becomes uneven, whereby the pore shape changes. If Zr component is unevenly distributed on the porous silica surface, at a portion where no Zr component is present on the porous silica surface, the alkali resistance may be lowered.

According to the present invention, the porous silica is treated with precursor P together with precursor Zr, whereby it is possible to maintain the pore shape before and after the treatment. Since the pore shape is maintained, it is understood that Zr component is uniformly formed on the porous silica surface.

This is considered to be such that P component and Zr component will interact on the surface of the porous silica, so that Zr component will be more evenly distributed on the surface of the porous silica.

Therefore, according to the present invention, since Zr component is uniformly distributed on the porous silica, it is possible to improve the alkali resistance.

Further, according to the present invention, by treating the porous silica with precursor Zr and precursor P, it is possible to maintain the pore shape before and after the treatment. It is thereby possible to prevent lowering of the number of theoretical plates in a case where the porous silica is used as a chromatography carrier, and it is possible to obtain a porous silica having a high number of theoretical plates.

The porous silica contains from 1 to 15 μmol/m² of zirconium atoms per unit specific surface area. Hereinafter, “zirconium atoms” will also be referred to as “Zr atoms”.

Zr component having Zr atoms is preferably present on the surface of the porous silica. Here, the expression “present on the surface” also means that Zr component is present with a concentration gradient in the inward direction from the surface of the silica.

By attaching precursor Zr to a porous silica, followed by calcining, it is possible to let Zr component be present on the surface of the porous silica.

Precursor Zr may, for example, be zirconium (IV) chloride, zirconium (III) chloride, zirconium oxychloride, a tetraalkoxy zirconium, a dialkoxy zirconium dichloride, etc.

Examples of the tetraalkoxy zirconium may be zirconium tetra-n-propoxide, zirconium tetra-iso-propoxide, zirconium tetraethoxide, zirconium tetra-n-butoxide, etc.

One of these may be used alone, or two or more of them may be used in combination.

By calcining such precursor Zr, it is possible to form Zr component on the surface of the porous silica.

When the content of Zr atoms is at least 1 μmol/m² per unit specific surface area of the porous silica, it is possible to increase the function for alkali resistance. This value is preferably at least 2 μmol/m², more preferably at least 2.5 μmol/m².

On the other hand, when the content of Zr atoms is at most 15 μmol/m² per unit specific surface area of the porous silica, it is possible to maintain the pore shape of the porous silica. On the other hand, if Zr atoms are excessively incorporated, the number of theoretical plates may decrease. The value of the content of Zr atoms is preferably at most 13.5 μmol/m², more preferably at most 10 μmol/m².

Here, the number of moles of Zr atoms per unit specific surface area can be obtained by obtaining the Zr atom content (mass %) in the entire porous silica by an ICP analysis, and calculating from this Zr atom content (mass %) and the specific surface area of the porous silica. The method for measuring the specific surface area of the porous silica is as described later.

The porous silica contains from 1 to 25 μmol/m² of phosphorus atoms per unit specific surface area. In the following, “phosphorus atoms” will also be referred to as “P atoms”.

P component having P atoms is preferably present on the surface of the porous silica.

By attaching precursor P to a porous silica, followed by calcining, it is possible to let P component be present on the surface of the porous silica.

Precursor P may, for example, be phosphorus oxychloride, phosphoryl ethanolamine, potassium dihydrogen phosphate, dipotassium hydrogen phosphate, sodium dihydrogen phosphate, disodium hydrogen phosphate, a trialkyl phosphine, triphenyl phosphine, a trialkylphosphine oxide, triphenyl phosphine oxide, a phosphoric acid ester, polyphosphoric acid and its salt, orthophosphoric acid and its salt, diphosphorus pentoxide, etc. One of these may be used alone, or two or more of them may be used in combination.

By attaching such precursor P to a porous silica, followed by calcining, it is possible to form P component on the surface of the porous silica.

When the content of P atoms is at least 1 μmol/m² per unit specific surface area of the porous silica, it is possible to increase the function for alkali resistance. In the case of incorporating only Zr component, Zr component may be unevenly formed on the surface of the porous silica. In the present invention, it has been found that if the distribution of Zr component is non-uniform, alkali resistance cannot be sufficiently obtained. When P component is incorporated together with Zr component, the distribution of Zr component becomes uniform, and it is thereby possible to improve the alkali resistance as a result.

The value for the content of P atoms is preferably at least 3.0 μmol/m², more preferably at least 10.0 μmol/m².

On the other hand, the content of P atoms is preferably at most 25 μmol/m² per unit specific surface area of the porous silica. It is considered possible to thereby form Zr component with uniform distribution, while maintaining the pore shape of the porous silica. Thus, it is possible to prevent lowering of the number of theoretical plates.

The value for the content of P atoms is preferably at most 20 μmol/m², more preferably at most 17.5 μmol/m².

Here, as the method for measuring the number of moles of P atoms per unit specific surface area, the measurement may be carried out in the same manner as for Zr atoms as described above.

The porous silica (A) preferably has the following characteristics.

The shape of the porous silica (A) is preferably in the form of spherical particles and may be spherical including true spheres and ellipsoids. In its application as a chromatographic carrier, it is preferably in a shape close to a true sphere from the viewpoint of packing properties to a column or suppression of the pressure loss during use.

The average particle diameter of the porous silica (A) to be used in an affinity chromatography carrier, is preferably at least 5 μm, more preferably at least 7 μm, further preferably at least 10 μm.

On the other hand, the average particle diameter of the porous silica (A), is preferably at most 500 μm, more preferably at most 200 μm, further preferably at most 100 μm.

Here, the average particle diameter of the porous silica (A) is measured by a measuring method in accordance with the Coulter counter method.

In the particle size distribution of the porous silica (A) to be used in the affinity chromatography carrier, the ratio (D90/D10) of the 90% particle diameter (D90) to the 10% particle diameter (D10) from the small side of the cumulative amount as calculated by volume, is preferably at most 3, more preferably at most 2, further preferably at most 1.6, in the laser type light scattering method. When D90/D10 is at most 1.6, even in the case of a porous silica (A) having a small average particle diameter, it is possible to prevent an increase in pressure loss. Further, as D90/D10 is closer to 1, the particle size distribution becomes uniform, such being preferred.

Here, D90/D10 of the porous silica (A) is measured by a measuring method in accordance with the Coulter counter method. In the particle size distribution by the Coulter counter method, when volumes of particle diameters are integrated from the small side, D10 is a particle diameter where the integrated volume becomes 10% of the total volume, and likewise, D90 is a particle diameter where the integrated volume becomes 90%. D90/D10 is a ratio of these particle diameters, and therefore, can be obtained from D10 and D90 obtained by measuring the porous silica (A) by e.g. “Multisizer III” manufactured by Beckman Coulter, Inc.

The specific surface area of the porous silica (A) to be used in an affinity chromatography carrier is, by a mercury penetration method, preferably from 55 m²/g to 75 m²/g, more preferably from 60 m²/g to 75 m²/g. The specific surface area may be optimized depending upon the purpose together with the above-mentioned average pore diameter and pore volume. When the specific surface area is large, the ability to adsorb antibody molecules will be improved, such being preferred, but if it becomes large, the strength of the porous silica (A) tends to be lowered, and therefore, it is preferred to set the specific surface area within the above range.

The average pore diameter of the porous silica (A) to be used in an affinity chromatography carrier is, by the mercury penetration method, from 30 nm to 500 nm, preferably from 70 nm to 300 nm, more preferably from 85 nm to 115 nm. When the average pore diameter is at least 30 nm, it is possible to improve the ability to adsorb antibody molecules thereby to provide a carrier having a large capacity. When the average pore diameter is at most 500 nm, it is possible to prevent a decrease in strength of the porous silica (A), while maintaining the adsorption amount of antibody molecules to be large.

The pore volume of the porous silica (A) to be used in an affinity chromatography carrier is, by the mercury penetration method, at least 0.5 mL/g, preferably at least 1.0 mL/g, more preferably at least 1.5 mL/g. When the pore volume is at least 0.5 mL/g, it is possible to improve the ability to adsorb antibody molecules and thereby to provide a carrier having a large capacity. Further, the pore volume is, from the viewpoint of strength of the porous silica (A), preferably at most 2.0 mL/g.

These pore properties by the mercury penetration method can be measured by using e.g. “mercury porosimeter AutoPore IV9510” manufactured by Shimadzu Corporation.

Further, the porous silica (A) to be used in a cation exchange chromatographic carrier, anion exchange chromatographic carrier, reverse phase chromatographic carrier, or size exclusion chromatographic carrier, is not particularly limited, but is usually one having an average particle size of from 0.5 to 10,000 μm, preferably from 1 to 500 μm, an average pore diameter of from 0.5 to 600 nm, and a specific surface area at a level of from 50 to 10,000 m²/g, preferably from 100 to 1,000 m²/g.

The above-described porous silica (A) may be used as a chromatographic carrier. As the chromatographic carrier, it is possible to use one wherein the above porous silica (A) is contained as the support, and a ligand is immobilized to the porous silica.

In an affinity chromatographic carrier, as the ligand, protein A, protein G, concanavalin A, an antigen, an antibody or the like may be used.

In a cation exchange chromatographic carrier, as the ligand, a sulfonic acid, a carboxy group or the like may be used.

In an anion exchange chromatographic carrier, as the ligand, an amine such as a primary amine, a secondary amine, a tertiary amine or a quaternary amine may be used.

In a reverse phase chromatographic carrier, as the ligand, an alkyl group, a phenyl group, a fluorinated alkyl group or the like may be used. As the alkyl group, it is preferred to use an alkyl group having from 1 to 30 carbon atoms, and, for example, a methyl group, a butyl group, an octyl group, an octadecyl group or the like may be mentioned.

In a size exclusion chromatographic carrier, as the ligand, a diol group or the like may be used. In the case of using protein A as the ligand, in an affinity chromatographic carrier, by using the porous silica (A) as a substrate, the immobilized amount of protein A may be made to be at least 9.5 mg/mL-bed, more preferably at least 10 mg/mL-bed, further preferably at least 10.5 mg/mL-bed. The upper limit of the immobilized amount of protein A is not particularly limited, but is preferably at most 30 mg/mL-bed, more preferably at most 25 mg/mL-bed.

Further, the dynamic binding capacity is at least 35 mg/mL-bed, and when immersed for 20 hours in a 500 mM aqueous sodium hydroxide solution at room temperature, the ratio of the dynamic binding capacity after the immersion to the dynamic binding capacity before the immersion is preferably at least 60%.

Here, as the method for measuring the immobilized amount of protein A, the carrier having protein A immobilized thereto may be dried, and this carrier may be subjected to an elemental analysis to obtain the immobilized amount.

Now, the method for producing a porous silica of the present invention will be described.

The method for producing a porous silica of the present invention is characterized by attaching precursor P and precursor Zr in an optional order or simultaneously to a porous silica, followed by calcining.

Hereinafter, treatment for attaching precursor Zr and precursor P to a porous silica, will also be referred to as “Zr treatment” and “P treatment”. By conducting calcining after P treatment and Zr treatment, a desired porous silica is produced.

By the method for producing a porous silica of the present invention, it is possible to produce the porous silica (A), and the method is preferred as a method for producing the porous silica (A). However, not limited to the porous silica (A), it is also possible to produce a porous silica other than the porous silica (A), which comprises a phosphorus oxide component and a zirconium oxide component.

In the method for producing a porous silica of the present invention, by using the precursor P and precursor Zr in such amounts that the P atom content and the Zr atom content in the obtainable porous silica would be the above-mentioned contents in the porous silica (A), it is possible to obtain the porous silica (A). By using the precursors in such amounts that at least one of the P atom content and the Zr atom content in the obtainable porous silica would be other than the content in the porous silica (A), it is possible to obtain a porous silica comprising a phosphorus oxide component and a zirconium oxide component, other than the porous silica (A).

A porous silica other than the porous silica (A) obtainable by the production method of the present invention, may, for example, be a porous silica wherein, as the amount of atoms per unit specific surface area of the porous silica, the P atom content is from 1 μmol/m² to 25 μmol/m², and the Zr atom content is less than 1 μmol/m² or more than 15 μmol/m², or a porous silica wherein the Zr atom content is from 1 μmol/m² to 15 μmol/m², and the P atom content is less than 1 μmol/m² or more than 25 μmol/m². The lower limit of the P atom content in the porous silica other than the porous silica (A) is preferably 0.01 μmol/m², and the upper limit is preferably 50 μmol/m². The lower limit of the Zr atom content is preferably 0.01 μmol/m², and the upper limit is preferably 30 μmol/m².

The method for producing a porous silica of the present invention is preferably a method of producing the porous silica (A). Hereinafter, the production method of the present invention will be described with reference to the method for producing the porous silica (A) as an example. Here, a porous silica other than the porous silica (A) may be produced by a similar method by changing the amount of precursor P or precursor Zr.

The silica as raw material is not particularly limited, but is preferably a silica having a shape and pore properties suitable for a chromatographic carrier.

For example, the average particle diameter of the silica as raw material, D90/D10, the specific surface area, the average pore diameter and the pore volume are preferably in the same ranges as of the above-mentioned porous silica (A).

Changes in these properties will thereby be less as between before and after each of Zr treatment, P treatment and the calcining.

The method for producing a porous silica as raw material is not particularly limited. For example, a spraying method or an emulsion-gelation method may be mentioned. As the emulsion-gelation method, for example, a continuous phase and a disperse phase containing a silica precursor, may be emulsified, and the obtained emulsion may be gelled to obtain a porous silica. If necessary, treatment may be conducted as the case requires in order to increase the average pore diameter and the pore volume of the porous silica.

As the emulsification method, a method is preferred in which the dispersed phase containing a silica precursor is supplied via micropores or a porous membrane to the continuous phase to prepare the emulsion. Thus, by preparing an emulsion with a uniform droplet size, it is possible to obtain a porous silica having a uniform particle size, as a result. As such an emulsification method, it is possible to use a micro-mixer method or a membrane emulsification method.

In the production method of the present invention, it is possible to preferably use a porous silica produced by a micro-mixer method. The micro mixer method is disclosed, for example, in WO2013/062105.

As the method for attaching precursor P and precursor Zr to a porous silica, it is possible to use a slurry concentration-drying method, a slurry filtration method, a dry method, a gas phase method, etc.

A preferred embodiment of the production method is a method wherein to a porous silica, precursor P is first attached and then, precursor Zr is attached, followed by calcining. As another embodiment, there may be a method wherein to a porous silica, precursor P and precursor Zr are simultaneously attached, followed by calcining, or a method wherein to a porous silica, precursor Zr is attached, and then, precursor P is attached, followed by calcining.

The slurry concentration-drying method is a method wherein to a porous silica as raw material, a precursor P solution and a precursor Zr solution may be contacted in an optional order or simultaneously, concentrated (preferably concentrated under reduced pressure) to dryness, dried and calcined to obtain the porous silica (A). For example, a porous silica and a precursor P solution are mixed to let precursor

P be in contact to the porous silica, followed by concentration to dryness under a pressure of from atmospheric pressure to -0.1 MPa at a temperature of from 10 to 100° C. and then by drying at a temperature of from 10 to 180° C. for from 5 minutes to 48 hours. Then, this dried product and a precursor Zr solution are mixed to let precursor Zr be in contact to the porous silica of the dried product.

Precursor P has a high affinity to water or a polar organic solvent, and therefore, as the solvent to be used for the precursor P solution, it is possible to preferably use distilled water, an aqueous solvent such as saline, etc. or an organic solvent such as 1-propanol, acetonitrile, etc.

In the case of conducting Zr treatment after P treatment, in order not to let precursor P be eluted by the solvent to be used in Zr treatment, as the solvent to be used for the precursor Zr solution, it is preferred to use an organic solvent, and it is possible to preferably use an organic solvent such as 1-propanol, acetonitrile, toluene, ethyl acetate, hexane, etc.

Further, in the case of conducting P treatment after Zr treatment, a porous silica and a precursor Zr solution are mixed to let precursor Zr be in contact to the porous silica, followed by concentration to dryness and drying under the same conditions as described above, and then, the obtained dried product and a precursor P solution are mixed to let precursor P be in contact to the porous silica of the dried product. In this case, as the solvent to be used for the precursor Zr solution, it is preferred to use distilled water, an aqueous solvent such as saline, etc. or a water-soluble organic solvent such as 1-propanol, acetonitrile, etc.

Further, in the case of conducting P treatment and Zr treatment simultaneously, a porous silica, and a precursor P solution and a precursor Zr solution, are mixed to let precursor P and precursor Zr be in contact to the porous silica. In this case, to be suitable for precursor P, it is preferred to use distilled water, an aqueous solvent such as saline, etc. or a water-soluble organic solvent such as 1-propanol, acetonitrile, etc.

The concentration of the porous silica dispersion in the final stage after P treatment and Zr treatment, is preferably carried out under a pressure of from atmospheric pressure to -0.1 MPa at a temperature of from 10 to 100° C.

The drying in the final stage is preferably carried out in one step, or two or more steps, at a temperature of from 10 to 180° C. for a period of time in a range of from 5 minutes to 48 hours.

The above drying is followed by calcining. The calcining temperature is preferably from 300 to 500° C., more preferably from 350 to 450° C. It is thereby possible to prevent a change in properties of the porous silica, and to form Zr component and P component from precursor Zr and precursor P. The calcining time is preferably from 30 minutes to 24 hours.

A preferred slurry concentration-drying method is a method wherein to a porous silica as raw material, an aqueous solvent solution of water-soluble precursor P is contacted, followed by concentration to dryness and drying, and to this dried product, an organic solvent solution of precursor Zr is contacted, followed by concentration to dryness, drying and calcining.

The slurry filtration method is a method wherein the solvent is removed by filtration in place of the concentration to dryness in the slurry concentration-drying method, and subsequent to the removal of the solvent, the porous silica (A) is obtained in the same manner as in the slurry concentration-drying method.

The contact of the precursor P solution and the precursor Zr solution, the selection of the solvents to be used, the drying, the calcining, etc. may be conducted in the same manner as in the slurry concentration-drying method as described above.

A preferred slurry filtration method is a method wherein to a porous silica as raw material, an aqueous solvent solution of water-soluble precursor P is contacted, followed by filtration and drying, and to this dried product, an organic solvent solution of precursor Zr is contacted, followed by filtration, drying and calcining.

As the slurry filtration method, a method using an aminopropyl-modified porous silica as a porous silica as raw material is also preferred. By using an aminopropyl-modified porous silica as a porous silica as raw material, it is possible to prevent re-elution of precursor P, and precursor Zr can be treated with an aqueous solvent. In this case, each filtration is preferably followed by washing with an aqueous solvent or an organic solvent.

The dry method is a method wherein to a porous silica as raw material, a precursor P solution and a precursor Zr solution are contacted in an optional order or simultaneously, to let the entire amounts of these solutions be absorbed to form a powder, and this powder is dried to remove the absorbed solvent, and subsequent to the removal of the solvent, the porous silica (A) is obtained in the same manner as in the above-described slurry concentration-drying method.

The contact of the precursor P solution and the precursor Zr solution, the selection of solvents, the drying, the calcining, etc. may be conducted in the same manner as in the slurry concentration-drying method as described above.

A preferred dry method is a method wherein to a porous silica as raw material, an aqueous solvent solution of water-soluble precursor P is contacted to let its entire amount be absorbed, followed by drying, and to this dried product, an organic solvent solution of precursor Zr is contacted to let its entire amount absorbed, followed by drying and calcining.

The vapor-phase method is a method wherein precursor P and/or precursor Zr, is heated to be gasified or sublimed, and the resulting gas is contacted with a porous silica as raw material and calcined to obtain the porous silica (A).

Further, in the above-described production method of the porous silica (A), the amounts of precursor P and precursor Zr to be used, are such amounts that the P atom content and Zr atom content in the obtainable porous silica (A) would be the above-mentioned contents.

Next, an example of a method for producing an affinity chromatographic carrier by immobilizing protein A to the porous silica (A) will be described.

The method for immobilizing protein A to the above-mentioned porous silica (A) may be a method wherein a structure called a linker is interposed between the porous silica (A) and a ligand, and one end of the linker is bound to the porous silica (A) and the other end of the linker is bound to the ligand, thereby to immobilize the ligand to the porous silica.

Now, as an example, a method will be described wherein the porous silica (A) and an epoxy group-containing compound are reacted, and further, protein A is reacted thereto.

By reacting the porous silica (A) and an epoxy group-containing compound, it is possible to immobilize an epoxy group-containing compound to the porous silica (A) surface, thereby to form a linker. The linker has an epoxy group at the terminal.

As the epoxy group-containing compound, a silane coupling agent having an epoxy group is preferably used. As the epoxy group-containing silane coupling agent, it is possible to use 3-glycidoxypropyltrimethoxysilane, 3-glycidoxypropyl methyl diethoxy silane, 2-(3,4-epoxycyclohexyl)ethyltrimethoxysilane, etc.

The method for reacting the porous silica (A) and an epoxy group-containing compound, is not particularly limited, but, for example, it is possible to use a method wherein the porous silica (A) and an epoxy group-containing compound are heated in a solvent. The reaction temperature is, for example, from about 30 to 400° C., preferably from 100 to 300° C. The reaction time is, for example, from about 0.5 to 40 hours, preferably from 3 to 20 hours.

The solvent is not particularly limited, so long as it does not react with the epoxy group-containing compound, and it is stable at the reaction temperature. From the viewpoint of the solubility of the epoxy group-containing compound, the boiling point, and further the affinity to other solvents (i.e. removability at the time of washing), it is possible to use usually benzene, toluene, xylene, octane, isooctane, tetrachloroethylene, chlorobenzene, bromobenzene, etc. Further, the reaction operation may be conducted under reflux of the solvent.

The immobilized amount of the epoxy group-containing compound is usually preferably large, i.e. an amount to densely cover the entire surface of the porous silica (A) with a view to improving the alkali resistance of the porous silica (A). Specifically, it is preferred to conduct the reaction so that the amount of the epoxy group-containing compound per 1 g of the porous silica (A) (the value obtained by dividing the immobilized amount of the epoxy group-containing compound by the mass of the porous silica (A)) would be at least 220 μmol/g. The immobilized amount of the epoxy group-containing compound is more preferably from 220 to 320 μmol/g, particularly preferably from 240 to 300 μmol/g.

Here, the immobilized amount of the epoxy group-containing compound is obtained based on a known method. For example, it is possible to calculate the immobilized amount of the epoxy group-containing compound by using the mass of the porous silica (A) and the amount of carbon contained per molecule of the epoxy group-containing compound, based on the carbon content measured by an elemental analysis with respect to the porous silica (A) after immobilizing the epoxy group-containing compound.

In the reaction system of the porous silica (A) and the epoxy group-containing compound, further, an amine compound such as triethylamine, pyridine or N,N-diisopropylethylamine may be present. Thus, by the catalytic action of the amine, the reaction of the porous silica (A) and the epoxy group-containing compound may be facilitated.

Preferably, the obtained epoxy-modified porous silica (A) is further diol-formed and treated with glycerol polyglycidyl ether.

As the method for diol-formation, for example, it is possible to use a method of obtaining a diol-modified porous silica by ring-opening an epoxy group by an acid such as dilute hydrochloric acid.

As the method for treatment with glycerol polyglycidyl ether, for example, glycerol polyglycidyl ether (trade name “Denacol EX-314”, manufactured by Nagase ChemteX Corporation) and an organic solvent such as methanol, are mixed, followed by drying. To this dried product, an organic solvent such as decane and boron trifluoride diethyl ether are mixed, followed by washing and drying to obtain a glycerol polyglycidyl ether modified porous silica (A).

The obtained glycerol polyglycidyl ether modified porous silica (A) is formylated, whereby it is possible to let protein A be carried on the porous silica (A) by a reductive amination reaction. Formylation may be carried out, for example, by treating the porous silica with sodium periodate.

Then, to the porous silica (A) having a linker introduced, protein A will be immobilized. As protein A, one having lysine amino groups may be used. Among them, recombinant protein A may preferably be used.

The method for binding a ligand to the above-described linker structure of the porous silica (A) is not particularly limited, but may be carried out in a suitable solvent by mixing the porous silica (A) and a solution containing protein A and using a catalyst, reagent, etc. as the case requires. In the reaction of the linker structure and the ligand, for example, the reaction temperature may be set to be from 20 to 30° C., and the reaction time may be set to be from 1 to 24 hours. The pH of the reaction system is preferably from 8 to 9.5 and may be adjusted by using a buffer solution.

The amount of protein A to be blended, is preferably an amount corresponding to at least 10.0 mg/mL-bed, more preferably at least 11.5 mg/mL-bed, per packing volume.

Further, in order to deactivate residual formyl groups in the linker structure, after binding the ligand to the porous silica, it is preferred to have them reacted with ethanolamine or tris (hydroxymethyl) am inomethane.

Further, then it is preferred to conduct treatment with e.g. trimethylamine borane or sodium cyanoborohydride, whereby formed imine bonds will be reduced to more stable amine bonds.

The post-treatment after the reaction may be carried out by a method commonly adopted, such as filtration and washing, without any particular limitation.

The washing may be carried out multiple times by using e.g. a phosphate buffered saline (PBS, pH 7.4), a citrate buffer solution (pH 2.2), an aqueous sodium hydroxide solution, distilled water, etc.

Further, the carrier having a ligand immobilized, is preferably stored as refrigerated at from 4 to 8° C. at pH 5 to 6, and as a preservative, benzyl alcohol or the like may further be added.

As the immobilized amount of protein A, the reaction is preferably carried out so that the amount of protein A per packing volume (the value obtained by dividing the immobilized amount of protein A by the packing volume) would be at least 9.5 mg/mL-bed. More preferably, the immobilized amount of protein A is at least 10 mg/mL-bed.

The immobilized amount of protein A is obtained based on a known method. For example, it is possible to calculate the amount immobilized to the porous silica (A) from the difference between the concentration of the blended protein A solution, and the concentration of the protein A solution obtainable by separating the porous silica (A) after binding the protein A by mixing the solution and the porous silica (A). The solution concentration can be measured optically.

The size exclusion chromatographic carrier of the present invention has a high number of theoretical plates. The number of theoretical plates can be obtained as follows. That is, it is obtainable by the following calculation formula from a peak detected by measurement of standard polystyrene with a molecular weight of 453 using a column packed with the porous silica (A).

N=5.54×[t/W_{0.5}]²

Here, N is the number of theoretical plates, t is the retention time of the component, and W_{0.5} is the peak width at 50% position of the peak height. The number of theoretical plates is preferably at least 2,000 plates, more preferably at least 3,000 plates. Further, the number of theoretical plates is preferably at most 500,000 plates, more preferably at most 100,000 plates.

Further, the affinity chromatographic carrier having protein A immobilized, of the present invention, has high alkali resistance and is excellent in separating performance at a high flow rate. The separating performance is represented by a dynamic binding capacity (DBC). By adding a standard protein solution with a known concentration to a column and monitoring the absorbance of the eluate, DBC is obtained from the amount of added protein at the time when 10% leakage of the absorbance of the added sample is observed. DBC is preferably at least 35 mg/mL-bed, more preferably at least 40 mg/mL-bed. The upper limit value of DBC is not particularly limited, but is preferably at most 110 mg/mL-bed, more preferably at most 100 mg/mL-bed.

Further, the alkali resistance may be obtained by retention of DBC as between before and after immersion in alkaline. That is, by comparing DBC as between before and after immersion for 20 hours in a 500 mM aqueous sodium hydroxide solution at room temperature, the proportion of DBC after the immersion to DBC before the immersion is calculated. The proportion is preferably at least 60%, more preferably at least 70%. The ideal upper limit is 100%.

In the case of conducting chromatography by using the above-described chromatographic carrier, the chromatographic carrier is used as packed to a column. As the column, a column made of glass, stainless steel, a resin, etc. may suitably be used.

The present invention is also a method for conducting chromatography by using the above chromatographic carrier. The present invention is further a method for producing a protein by purifying the protein by using the above chromatographic carrier. It is particularly preferred that the protein is IgG.

### EXAMPLES

Now, the present invention will be described in further detail with reference to Examples, but the present invention is not limited thereto. In the following description, for common components, the same ones are used. Further, for components with no particular identification, those manufactured by Kanto Chemical Co., Inc. are used. Ex. 1 to 28

### <Preparation of Porous Silica (A)>

Table 1 shows the formulation of the porous silica in Ex. 1 to 28.

In Ex. 1 to 28, as a porous silica as raw material, “M.S.GEL SIL EP-DF-5-300A” manufactured by AGC Si-Tech Co., Ltd. was used. Hereinafter, this porous silica as raw material will be referred to as silica gel.

The physical properties of this silica gel are as follows.

Average particle size: 4.44 μm, uniformity coefficient (D90/D10): 1.44, average pore diameter: 26.2 nm, pore volume: 1.30 mL/g, specific surface area: 191 m²/g.

Here, the average particle diameter was measured by the Coulter counter method using Multisizer III (manufactured by Beckman Coulter, Inc.). The uniformity coefficient was obtained by measuring D10 particle diameter and D90 particle diameter by the same method, and calculating the ratio (D90/D10). The average pore diameter, pore volume and specific surface area, were measured by the mercury penetration method by using AutoPore IV9510 (manufactured by Shimadzu Corporation). The same applies hereinafter.

Ex. 1 is an example for untreated silica gel, Ex. 2 is an example where no P treatment was conducted, Ex. 3 to 16 and 22 are examples prepared by the slurry concentration-dying method (shown by “A” under “Treating method” in Table 1) according to Production Example 1, Ex. 17 is an example prepared by the slurry liquid filtration method (shown by “B” under “Treating method” in Table 1) according to Production Example 2, and Ex. 18 to 21 are examples prepared by the dry method (shown by “C” under “Treating method” in Table 1) according to Production Example 3.

### Production Example 1

### Slurry Concentration-Drying Method

The production method in Ex. 3 will be described.

A mixed liquid of 5 g of silica gel, 69 mL of distilled water and 0.221 g of potassium dihydrogen phosphate (KH₂PO₄) was stirred at room temperature for 30 minutes. This mixed liquid was concentrated under reduced pressure to dryness at 72° C. under −0.09 MPa, and then dried at 180° C. for one day and night.

To this dried product, 69 mL of 1-propanol and 3.77 mL of a 70 mass % zirconium tetra-n-propoxide solution in 1-propanol (manufactured by Tokyo Chemical Industry Co., Ltd., hereinafter may be abbreviated as 70% Zr(OPr)₄) were added and stirred at room temperature for 4 hours.

Thereafter, the mixture was concentrated under reduced pressure to dryness at 60° C. under −0.09 MPa, then air-dried for one day and night at room temperature, 3 hours at 70° C., and 5 hours at 120° C. Then, the dried product was calcined at 400° C. for 7 hours, to obtain a porous silica (A).

In Ex. 2, in accordance with the formulation in Table 1, a porous silica was obtained in the same manner as in Ex. 3 except that no P treatment was conducted.

In each of Ex. 4 to 8, 10 to 16 and 22, in according with the formulation in Table 1, a porous silica was obtained in the same manner as in Ex. 3.

In Ex. 9, in accordance with the formulation in Table 1, a porous silica was obtained in the same manner as in Ex. 3 except that no Zr treatment was conducted.

### Production Example 2

### Slurry Filtration Method

The production method in Ex. 17 will be described.

A mixed solution of 7 g silica gel, 97 mL of distilled water and 1.456 g of potassium dihydrogen phosphate (KH₂PO₄) was stirred at room temperature for 30 minutes. This mixture was subjected to filtration and then dried at 180° C. for one day and night.

To this dried product, 97 mL of 1-propanol and 5.52 mL of a 75 mass % zirconium tetra-n-propoxide solution in 1-propanol (ORGATIX ZA-45, manufactured by Matsumoto Fine Chemical Co., Ltd., hereinafter may be abbreviated as 75% Zr(OPr)₄) were added and stirred at room temperature for 4 hours.

This mixture was subjected to filtration, then air-dried at room temperature for one day and night, and dried at 70° C. for 3 hours and at 120° C. for 5 hours. Then, the dried product was calcined at 400° C. for 7 hours to obtain a porous silica (A).

### Production Example 3

### Dry Method

The production method in Ex 18 will be described.

To 5 g of silica gel, a mixed liquid of 5.86 mL of distilled water and 1.040 g of potassium dihydrogen phosphate (KH₂PO₄) was added and mixed at room temperature for 30 minutes, to let the entire amount of the mixed liquid be absorbed to the silica gel. This was dried at 180° C. for one day and night.

To this dried product, a mixed liquid of 2.11 mL of 1-propanol in and 3.94 mL of a 75 mass % zirconium tetra-n-propoxide solution in 1-propanol (ORGATIX ZA-45, manufactured by Matsumoto Fine Chemical Co., Ltd., (75% Zr(OPr)₄)) was added and mixed at room temperature for 30 minutes, to let the entire amount of the mixed liquid be absorbed to the silica gel.

This was air-dried at room temperature for one day and night, and dried at 70° C. for 3 hours and at 120° C. for 5 hours. Then, the dried product was calcined at 400° C. for 7 hours to obtain a porous silica (A).

In each of Ex. 19 to 21 and 23 to 28, in accordance with the formulation in Table 1, a porous silica (A) was obtained in the same manner as in Ex. 18.

<Evaluations>

Using the porous silica obtained in each of Ex. 1 to 28, the following evaluations were conducted. The results are shown in Table 2.

(Measurement of P Amount)

With respect to the obtained porous silica, P content (mass %) being the content of P atoms to the entire porous silica was measured by an ICP analysis. Then, from this P content and the specific surface area of the porous silica to be described later, P amount (μmol/m²) was calculated.

(Measurement of Zr Amount)

With respect to the obtained porous silica, Zr content (mass %) being the content of Zr atoms to the entire porous silica was measured by an ICP analysis. Then, from this Zr content and the specific surface area of the porous silica to be described later, Zr amount (μmol/m²) was calculated.

(Measurement of Si Elution Amount)

To 0.5 g of the porous silica produced in each of Ex. 1 to 28, 13 mL of a 50 mM sodium hydroxide aqueous solution was added and stirred at 23° C. for 3 hours by a rotary mixer. After centrifugation, the supernatant was filtered through a 0.45 μm membrane filter, and the silica concentration in the filtrate was obtained by using a molybdenum yellow spectrophotometry as a known method.

Further, using 100 mM and 500 mM sodium hydroxide (NaOH) aqueous solutions, the same operations were carried out.

With respect to 50 mM, 100 mM and 500 mM NaOH, by taking the Si elution amount in Ex. 1 as 100%, the relative Si elution amount in each of Ex. 2 to 22 was obtained by the following calculation. The results are shown in Table 2.

The relative Si elution amount of 50 mM NaOH in each Ex.=(Si elution amount of 50 mM NaOH in each Ex.)/(Si elution amount of 50 mM NaOH in Ex. 1)×100 (%).

The relative Si elution amount of 100 mM NaOH in each Ex=(Si elution amount of 100 mM NaOH in each Ex.)/(Si elution amount of 100 mM NaOH in Ex. 1)×100 (%).

The relative Si elution amount of 500 mM NaOH in each Ex.=(Si elution amount of 500 mM NaOH in each Ex.)/(Si elution amount of 500 mM NaOH in Ex. 1)×100 (%).

(GPC Evaluation using HPLC)

The porous silica prepared in each of Ex. 1 to 28 was packed in a stainless steel column with an inner diameter of 4.6 mm×a length 250 mm, and this column was mounted on a chromatography device “ELITE LaChrom (manufactured by HITACHI, Ltd.)”, and the measurement was conducted under the following conditions.

Eluent: tetrahydrofuran.

Flow rate: 0.3 mL/min.

Temperature: 23° C.

Detector: UV at 230 nm.

Sample: TSK GEL standard polystyrene (manufactured by Tosoh Corporation).

As the standard polystyrene, samples with the following mass average molecular weights were used.

A300: molecular weight 453, A1000: molecular weight 1,050, A2500: molecular weight 2,500, A5000: molecular weight 5,870, Fl: molecular weight 9,490, F2: molecular weight 17,100, F4: molecular weight 37,200, F10: molecular weight 98,900, F20: molecular weight 189,000, F40: molecular weight 397,000, F80: molecular weight 707,000, F128: molecular weight 1,110,000.

By using the column packed with the porous silica in each Ex., the measurement of the standard polystyrene with each molecular weight was conducted. With respect to the detected peak, the number of theoretical plates was obtained by the following calculation formula in accordance with the calculation method of DAB (German Pharmacopoeia).

N=5.54×[t/W_{0.5}]²

Here, N is the number of theoretical plates, t is the retention time of the component, and W_{0.5} is the peak width at 50% position of the peak height.

The number of theoretical plates for A300 (molecular weight 453) is shown in Table 2.

(Evaluation of Pore Physical Properties)

With respect to the obtained porous silica, the specific surface area (m²/g), pore volume (mL/g) and pore diameter (nm) were measured. These pore physical properties by a mercury penetration method were measured by “Mercury Porosimeter Autopore 1V9510” manufactured by Shimadzu Corporation. The results are shown in Table 2.

TABLE 1

| | | | P treatment | | | | | |
|---|---|---|---|---|---|---|---|---|
| | | | P source | | | | | |
| | | | | | | | | Potassium |
| | | | | | | | | pyrophosphate |
| No. | Treating method | Silica gel (g) | KH₂PO₄ (g) | H₃PO₄ (mL) | NaH₂PO₄ (g) | K₂HPO₄ (g) | Na₂HPO₄ (g) | (g) |
| Ex. 1 | — | — | — | — | — | — | — | — |
| Ex. 2 | A | 5 | — | — | — | — | — | — |
| Ex. 3 | A | 5 | 0.221 | — | — | — | — | — |
| Ex. 4 | A | 5 | 0.455 | — | — | — | — | — |
| Ex. 5 | A | 5 | 0.910 | — | — | — | — | — |
| Ex. 6 | A | 5 | 1.365 | — | — | — | — | — |
| Ex. 7 | A | 5 | 1.820 | — | — | — | — | — |
| Ex. 8 | A | 7 | 3.184 | — | — | — | — | — |
| Ex. 9 | A | 7 | 1.911 | — | — | — | — | — |
| Ex. 10 | A | 7 | 1.911 | — | — | — | — | — |
| Ex. 11 | A | 5 | 1.365 | — | — | — | — | — |
| Ex. 12 | A | 5 | 1.365 | — | — | — | — | — |
| Ex. 13 | A | 5 | 1.365 | — | — | — | — | — |
| Ex. 14 | A | 5 | 1.716 | — | — | — | — | — |
| Ex. 15 | A | 5 | 2.276 | — | — | — | — | — |
| Ex. 16 | A | 5 | 1.040 | — | — | — | — | — |
| Ex. 17 | B | 7 | 1.456 | — | — | — | — | — |
| Ex. 18 | C | 5 | 1.040 | — | — | — | — | — |
| Ex. 19 | C | 5 | 1.040 | — | — | — | — | — |
| Ex. 20 | C | 7 | — | 0.73 | — | — | — | — |
| Ex. 21 | C | 7 | — | — | 1.283 | — | — | — |
| Ex. 22 | A | 5 | 3.253 | — | — | — | — | — |
| Ex. 23 | C | 7 | — | — | — | — | — | 3.533 |
| Ex. 24 | C | 7 | — | — | — | 2.117 | — | — |
| Ex. 25 | C | 7 | — | — | — | — | 0.513 | — |
| Ex. 26 | C | 7 | — | — | — | — | — | 2.006 |
| Ex. 27 | C | 7 | — | — | — | — | — | — |
| Ex. 28 | C | 7 | 1.657 | — | — | — | — | — |

| | P treatment | | | | | | |
|---|---|---|---|---|---|---|---|
| | P source | | Zr treatment | | | | |
| | Sodium | | Zr source | | | | |
| | polyphosphate | Solvent | 70% Zr(OPr)₄ in | 75% Zr(OPr)₄ in | 87.5% Zr(OBu)₄ in | Solvent | |
| No. | (g) | H₂O (mL) | 1-PrOH (mL) | 1-PrOH (mL) | 1-BuOH (mL) | Type | Amount (mL) |
| Ex. 1 | — | — | — | — | — | — | — |
| Ex. 2 | — | — | 4.32 | — | — | 1-PrOH | 69 |
| Ex. 3 | — | 69 | 3.77 | — | — | 1-PrOH | 69 |
| Ex. 4 | — | 69 | 3.77 | — | — | 1-PrOH | 69 |
| Ex. 5 | — | 69 | 3.77 | — | — | 1-PrOH | 69 |
| Ex. 6 | — | 69 | 3.77 | — | — | 1-PrOH | 69 |
| Ex. 7 | — | 69 | 3.77 | — | — | 1-PrOH | 69 |
| Ex. 8 | — | 97 | 5.28 | — | — | 1-PrOH | 97 |
| Ex. 9 | — | 97 | — | — | — | — | — |
| Ex. 10 | — | 97 | 1.32 | — | — | 1-PrOH | 97 |
| Ex. 11 | — | 69 | 1.89 | — | — | 1-PrOH | 69 |
| Ex. 12 | — | 69 | 5.66 | — | — | 1-PrOH | 69 |
| Ex. 13 | — | 69 | 7.52 | — | — | 1-PrOH | 69 |
| Ex. 14 | — | 69 | 5.66 | — | — | 1-PrOH | 69 |
| Ex. 15 | — | 69 | 7.52 | — | — | 1-PrOH | 69 |
| Ex. 16 | — | 69 | 4.30 | — | — | 1-PrOH | 69 |
| Ex. 17 | — | 97 | — | 5.52 | — | 1-PrOH | 97 |
| Ex. 18 | — | 5.86 | — | 3.94 | — | 1-PrOH | 2.11 |
| Ex. 19 | — | 5.86 | — | 3.94 | — | AcOEt | 2.11 |
| Ex. 20 | — | 8.11 | — | 5.52 | — | 1-PrOH | 2.85 |
| Ex. 21 | — | 8.16 | — | 5.52 | — | 1-PrOH | 2.91 |
| Ex. 22 | — | 69 | 3.37 | — | — | 1-PrOH | 69 |
| Ex. 23 | — | 7.32 | — | 5.52 | — | 1-PrOH | 2.06 |
| Ex. 24 | — | 7.95 | — | 6.29 | — | 1-PrOH | 1.66 |
| Ex. 25 | — | 8.49 | — | 6.29 | — | 1-PrOH | 2.20 |
| Ex. 26 | — | 7.95 | — | 6.29 | — | 1-PrOH | 1.66 |
| Ex. 27 | 1.472 | 8.23 | — | 6.29 | — | 1-PrOH | 1.94 |
| Ex. 28 | — | 8.10 | — | — | 6.37 | 1-PrOH | 1.73 |

TABLE 2

| | | | | | | | | | Number | | | |
|---|---|---|---|---|---|---|---|---|---|---|---|---|
| | | | | | | | | | of | | | |
| | | | | | | Relative Si elution amount | | | theoretical | Specific | | Average |
| | | | | | | (%) | | | plates | surface | Pore | pore |
| | Treating | P amount | | Zr amount | | NaOH | NaOH | NaOH | A300 | area | volume | diameter |
| No. | method | Mass % | μmol/m² | Mass % | μmol/m² | 50 mM | 100 mM | 500 mM | Plates | m²/g | mL/g | nm |
| Ex. 1 | — | 0.0 | 0.0 | 0.0 | 0.0 | 100 | 100 | 100 | 6,996 | 191 | 1.30 | 26.6 |
| Ex. 2 | A | 0.0 | 0.0 | 14.1 | 10.0 | 36.0 | 34.3 | 34.2 | 1,881 | 158 | 0.97 | 24.6 |
| Ex. 3 | A | 0.8 | 1.7 | 13.1 | 9.5 | 10.6 | 9.9 | 10.3 | 2,840 | 152 | 0.92 | 24.6 |
| Ex. 4 | A | 1.5 | 3.3 | 12.9 | 9.6 | 13.3 | 11.2 | 17.1 | 4,964 | 152 | 0.84 | 23.6 |
| Ex. 5 | A | 2.9 | 6.8 | 12.3 | 9.8 | 6.6 | 5.2 | 7.3 | 4,660 | 139 | 0.78 | 24.3 |
| Ex. 6 | A | 4.2 | 10.4 | 11.7 | 9.8 | 4.8 | 8.6 | 9.0 | 5,841 | 126 | 0.70 | 23.9 |
| Ex. 7 | A | 5.1 | 12.9 | 10.2 | 8.8 | 5.2 | 7.4 | 9.8 | 6,150 | 109 | 0.67 | 25.4 |
| Ex. 8 | A | 6.1 | 16.7 | 11.1 | 10.3 | 7.9 | 7.5 | 9.3 | 5,835 | 81 | 0.57 | 27.6 |
| Ex. 9 | A | 5.0 | 10.4 | 0.0 | 0.0 | 64.3 | 63.4 | 67.8 | 6,699 | 131 | 0.91 | 26.7 |
| Ex. 10 | A | 4.8 | 10.5 | 3.5 | 2.6 | 14.4 | 13.9 | 15.1 | 7,259 | 124 | 0.85 | 26.7 |
| Ex. 11 | A | 4.8 | 11.2 | 7.0 | 5.6 | 9.8 | 9.3 | 14.7 | 6,677 | 128 | 0.80 | 25.2 |
| Ex. 12 | A | 3.6 | 9.2 | 14.8 | 12.8 | 8.8 | 6.6 | 11.0 | 4,111 | 138 | 0.64 | 22.7 |
| Ex. 13 | A | 3.5 | 9.5 | 18.3 | 17.0 | 9.1 | 6.7 | 10.5 | 1,749 | 136 | 0.54 | 21.2 |
| Ex. 14 | A | 4.9 | 13.5 | 14.7 | 13.7 | 4.8 | 6.1 | 9.5 | 6,258 | 98 | 0.57 | 26.3 |
| Ex. 15 | A | 5.8 | 18.0 | 17.4 | 18.4 | 4.0 | 4.3 | 8.3 | 1,516 | 97 | 0.44 | 22.4 |
| Ex. 16 | A | 3.4 | 8.2 | 12.7 | 10.4 | 2.9 | 4.2 | 6.9 | 5,394 | 110 | 0.72 | 27.4 |
| Ex. 17 | B | 0.6 | 1.1 | 3.4 | 2.1 | 23.5 | 22.3 | 25.5 | 6,814 | 169 | 1.13 | 25.9 |
| Ex. 18 | C | 3.4 | 8.2 | 12.7 | 10.4 | 4.6 | 5.8 | 5.4 | 5,234 | 140 | 0.73 | 24.6 |
| Ex. 19 | C | 3.2 | 7.8 | 13.4 | 11.0 | 5.1 | 4.4 | 3.9 | 5,743 | 119 | 0.70 | 26.1 |
| Ex. 20 | C | 3.4 | 7.6 | 12.4 | 9.4 | 8.1 | 9.6 | 9.8 | 5,952 | 103 | 0.80 | 30.1 |
| Ex. 21 | C | 3.3 | 7.7 | 12.4 | 9.8 | 5.8 | 6.2 | 5.9 | 4,339 | 111 | 0.75 | 27.2 |
| Ex. 22 | A | 7.6 | 22.3 | 9.9 | 9.9 | 8.7 | 7.8 | 10.1 | 3,223 | 82 | 0.50 | 24.2 |
| Ex. 23 | C | 5.1 | 14.4 | 9.7 | 9.3 | 8.1 | 10.9 | 8.1 | 6,154 | 50 | 0.47 | 36.7 |
| Ex. 24 | C | 3.1 | 7.2 | 13.3 | 10.5 | 6.1 | 4.4 | 9.6 | 4,342 | 82 | 0.61 | 34.0 |
| Ex. 25 | C | 1.1 | 2.2 | 15.5 | 10.6 | 10.9 | 9.3 | 12.8 | 6,379 | 142 | 0.80 | 23.9 |
| Ex. 26 | C | 3.3 | 7.7 | 12.9 | 10.3 | 5.7 | 5.0 | 4.7 | 4,534 | 67 | 0.57 | 42.4 |
| Ex. 27 | C | 3.6 | 8.1 | 13.5 | 10.3 | 4.8 | 3.3 | 7.9 | 5,701 | 120 | 0.70 | 24.1 |
| Ex. 28 | C | 3.7 | 8.1 | 12.4 | 9.3 | 11.1 | 11.5 | 16.0 | 5,112 | 151 | 0.72 | 22.0 |

As shown in each Table, in Examples satisfying the requirements of the present invention, alkali resistant was high because the relative Si elution amount was small, and it was also possible to prevent a decrease in the number of theoretical plates.

Ex. 3 to 8, 10 to 12, 14 and 16 to 28 satisfy the requirements of the present invention.

Specifically, Ex. 2 to 16 and 22 are examples wherein the slurry concentration-drying method (treating method: A) was used, whereby the following has been found.

In Ex. 2 wherein Zr treatment was conducted without conducting P treatment, although the relative Si elution amount was reduced, the number of theoretical plates decreased.

In Ex. 3 to 8 and 22 wherein P treatment and Zr treatment were conducted, the relative Si elution was small, and a decrease in the number of theoretical plates was prevented.

In Ex. 9 wherein P treatment was conducted without conducing Zr treatment, although the number of theoretical plates was not reduced, the relative Si elution amount was large.

In Ex. 10 to 12, 14 and 16 wherein P treatment and Zr treatment were conducted, the relative Si elution amount was small.

In Ex. 10, 11 and 14, further, a decrease in the number of theoretical plates was prevented.

In Ex. 13 and Ex. 15 wherein the Zr treatment amount was large, the relative Si elution became small, but the number of theoretical plates decreased.

In Ex. 17 wherein P treatment and Zr treatment were conducted by the slurry liquid filtration method (treating method: B), the relative Si elution amount was small, and a decrease in the number of theoretical plates was prevented.

In Ex. 18 to 21 and 22 to 28 wherein P treatment and Zr treatment were conducted by the dry method (treating method: C) the relative Si elution amount was small, and a decrease in the number of theoretical plates was prevented.

<Description of Graphs>

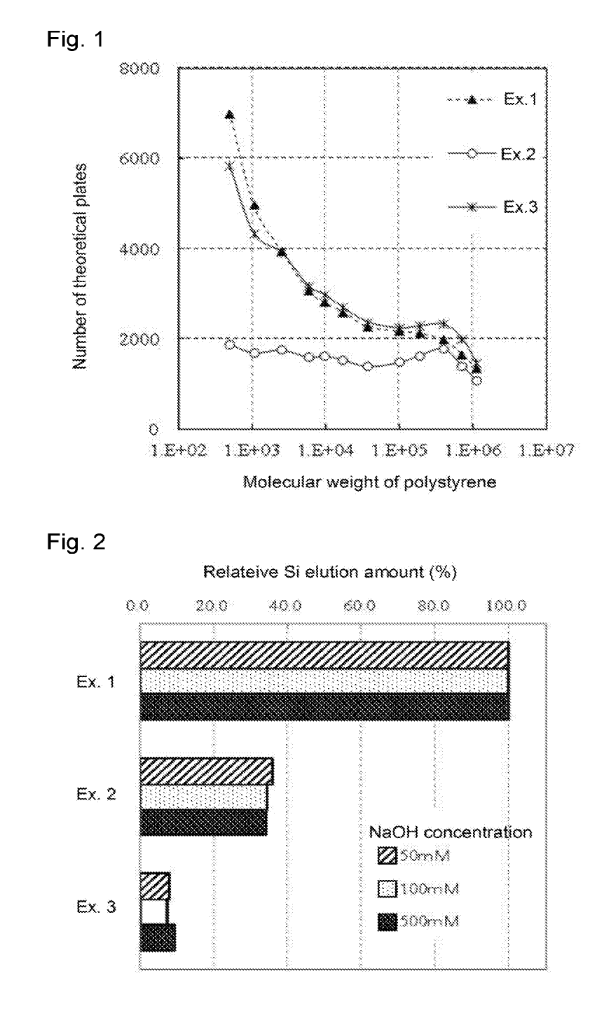

FIG. 1 shows a graph of the number of theoretical plates relative to the polystyrene molecular weight in Ex. 1, 2 and 8.

Ex. 1 represents untreated silica gel.

Ex. 2 is an example wherein only Zr treatment was conducted without conducing P treatment, and the number of theoretical plates decreased particularly at the low molecular weight side.

Ex. 8 is an example wherein P treatment and Zr treatment were conducted, and it was possible to prevent a decrease in the number of theoretical plates, against untreated Ex. 1.

Although not shown in the drawings, a similar tendency was observed in other Ex. satisfying the requirements of the present invention.

FIG. 2 shows a graph of the relative Si elution amount in Ex. 1, 2 and 8.

Ex. 1 represents untreated silica gel.

Ex. 2 is an example wherein only Zr treatment was conducted without conducting P treatment, and the relative Si elution amount was low, whereby alkali resistance was confirmed.

Ex. 8 is an example wherein P treatment and Zr treatment were conducted, and as compared with Ex. 2 wherein only Zr treatment was conducted, the relative Si elution amount was lower, and it was possible to further improve the alkali resistance.

Through FIGS. 1 and 2, it is seen that by conducting P treatment and Zr treatment, the pore shape of the porous silica can be maintained as between before and after the treatments, and further, alkali resistance can be improved.

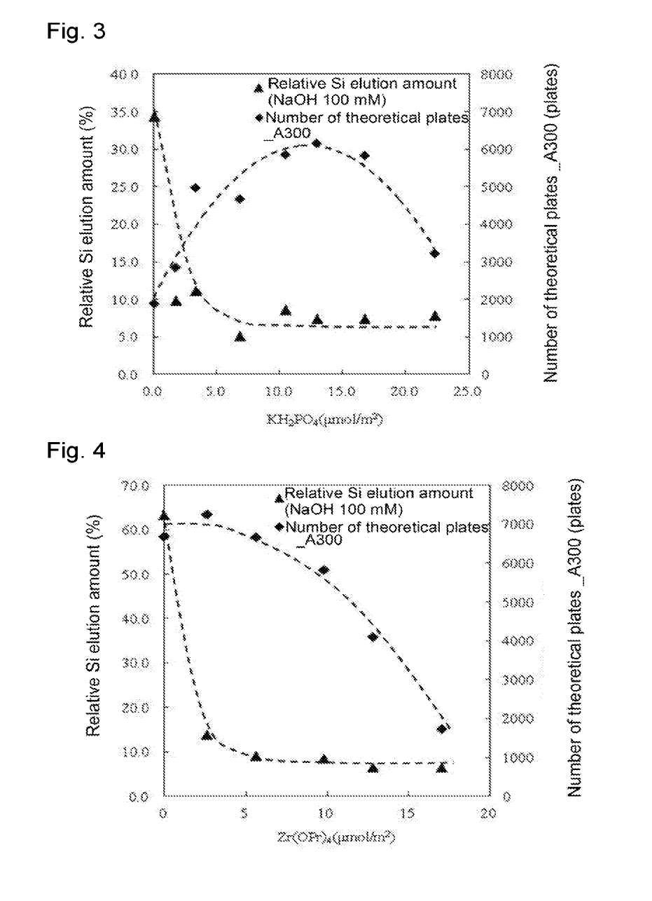

FIG. 3 shows a graph of the number of theoretical plates (A300) and the relative Si elution amount at 100 mM NaOH, to the KH₂PO₄ amount, by fixing the Zr(OPr)₄ amount by using the data in Ex. 2 to 8.

Ex. 2 is an example wherein only Zr treatment was conducted without conducting P treatment.

It is seen that as the KH₂PO₄ increases, the relative Si elution amount at 100 mM NaOH lowers, and the number of theoretical plates increases. The amount of P component is considered to hardly affect the pore shape.

From FIG. 3, it is seen that the content of P atoms is preferably at least 1 μmol/m², more preferably at least 3.0 μmol/m², further preferably at least 10.0 μmol/m².

FIG. 4 shows a graph of the number of theoretical plates (A300) and the relative Si elution amount at 100 mM NaOH, to the Zr(OPr)₄ amount, by fixing the KH₂PO₄ amount by using Ex. 7 and 9 to 13.

Ex. 9 is an example wherein only P treatment was conducted without conducting Zr treatment.

It is understood that as the Zr(OPr)₄ amount increases, the relative Si elution amount at 100 mM NaOH lowers, but the number of theoretical plates decreases. It is considered that when the amount of Zr component increases, the Zr component amount on the porous silica surface increases, whereby the pore shape changes, and the number of theoretical plates decreases.

From FIG. 4, it is understood that the content of Zr atoms is preferably from 1 to 15 μmol/m², more preferably from 2 to 13.5 μmol/m², further preferably from 2.5 to 10 μmol/m².

### Ex. 31 and 32

<Preparation of Porous Silica (A) having a Large Particle Diameter>

Table 3 shows the formulation of porous silica in each of Ex. 31 and 32.

In each of Ex. 31 and 32, “M.S.GEL SIL EP-DM-35-1000AW” manufactured by AGC Si-Tech Co., Ltd. was used as silica gel. (The synthesis method was in accordance with WO2013/062105.)

The physical properties of this silica gel were as follows.

Average particle size: 31.7 μm, uniformity coefficient (D90/D10): 1.29, average pore diameter: 107.0 nm, pore volume: 1.68 mL/g, specific surface area: 61 m²/g.

Ex. 31 represents untreated silica gel, and Example 32 is an example wherein the production was by a dry method in accordance with Production Example 4.

### Production Example 4

### Dry Method

The production method in Ex. 32 will be described.

To 50 g of silica gel, a mixed liquid of 83 mL of distilled water and 3.321 g of potassium dihydrogen phosphate (KH₂PO₄) was added and mixed at room temperature for 30 minutes, to let the entire amount of the mixed liquid be absorbed to the silica gel, followed by drying at 180° C. for one day and night.

To this dried product, 70 mL of 1-propanol and 12.50 mL of a 75 mass % zirconium tetra-n-propoxide solution in 1-propanol (ORGATIX ZA-45, manufactured by Matsumoto Fine Chemical Co., Ltd.) were added and mixed at room temperature for 30 minutes to let the entire amount of the mixed liquid be absorbed to the silica gel.

This was air-dried at room temperature for one day and night, and dried at 70° C. for 3 hours and at 120° C. for 5 hours. Then, the dried product was calcined at 400° C. for 7 hours to obtain a porous silica (A).

(Evaluation)

In the same manner as in Ex 1 to 28 as described above, the P amount, the Zr amount, the relative Si elution amount, the number of theoretical plates and the pore physical properties were obtained. The results are shown in Table 4.

Here, for the relative Si elution amount, by taking the Si elution amount in Ex. 31 as 100% with respect to each of 50 mM, 100 mM and 500 mM NaOH, the relative Si elution amount in Ex. 32 was obtained.

TABLE 3

| | | P treatment | | Zr treatment | |
|---|---|---|---|---|---|
| | | | Solvent | 75% | Solvent |
| | | KH₂PO₄ | H₂O | Zr(OPr)₄ | 1-PrOH |
| No. | Silica gel (g) | (g) | (mL) | (mL) | (mL) |
| Ex. 31 | — | — | — | — | — |
| Ex. 32 | 50 | 3.321 | 83 | 12.5 | 70 |

TABLE 4

| | | | | | | | | Number | | | |
|---|---|---|---|---|---|---|---|---|---|---|---|
| | | | | | | | | of | | | |
| | | | | | Relative Si elution amount | | | theoretical | Specific | | Average |
| | | | | | (%) | | | plates | surface | Pore | pore |
| | P amount | | Zr amount | | NaOH | NaOH | NaOH | A300 | area | volume | diameter |
| No. | Mass % | μmol/m² | Mass % | μmol/m² | 50 mM | 100 mM | 500 mM | Plates | m²/g | mL/g | nm |
| Ex. 31 | 0.0 | 0.0 | 0.0 | 0.0 | 100 | 100 | 100 | 3,239 | 61 | 1.68 | 107.0 |
| Ex. 32 | 1.3 | 7.8 | 4.9 | 10.0 | 5.7 | 6.5 | 5.1 | 2,761 | 52 | 1.38 | 103.2 |

As shown in Table 4, in Ex. 32 wherein using silica gel having an average pore diameter of 107.0 nm as raw material porous silica, P treatment and Zr treatment were conducted by a dry method, the relative Si elution amount was small, and further, a decrease in the number of theoretical plates was prevented relative to Ex. 31.

### Ex. 41 to 43

### Production Example 5

### Introduction of Linker and Ligand

To 5 g of the porous silica (A) obtained in Ex. 32, 22 mL of toluene, 0.85 mL of N,N-diisopropylethylamine and 1.08 mL of 3-glycidoxypropyltrimethoxysilane were added, followed by refluxing for 4.5 hours.

After cooling, the mixture was filtered and washed with 100 mL of toluene, 50 mL of tetrahydrofuran and 65 mL of methanol, in this order.

Then, 20 mL of a 0.5% aqueous hydrochloric acid was added, and the mixture was immersed at room temperature for one day and night, then filtered, washed with 150 mL of distilled water and 150 mL of methanol, and dried at 70° C. for one day and night.

To 3 g of the obtained diol-modified porous silica, a mixed solution of 0.64 g of Denacol EX-314 (manufactured by Nagase ChemteX Corporation) and 1.38 mL of methanol was added and mixed at room temperature for 30 minutes. Then, it was dried at 70° C. for one day and night.

To this, 18.2 mL of decane and 1.1 μL of boron trifluoride diethyl ether were added, and stirred at 110° C. for 4 hours. After cooling, the mixture was filtered, washed with 130 mL of hexane, 130 mL of tetrahydrofuran, 130 mL of a 0.5% aqueous hydrochloric acid solution, 650 mL of a 0.1 mol/L sodium hydroxide aqueous solution, 650 mL of distilled water and 130 mL of methanol, and dried at 70° C. for one day and night.

To 0.5 g of the obtained Denacol-porous silica (A), 2.5 mL of a 2.5 mass % sodium periodate aqueous solution was added, and the mixture was stirred at 23° C. for 1.5 hours by a rotary mixer and centrifuged, whereupon the supernatant was removed, and the residue was washed in similar operations with 30 mL of distilled water and 30 mL of a 0.2 mol/L phosphate buffer solution.

To this, 1.1 mL of a 0.2 mol/L phosphate buffer solution and 0.91 mL of recombinant protein A were added and stirred at 23° C. for 3 hours. Further, 0.142 mL of ethanolamine was added, followed by stirring at 35° C. for 1.5 hours, and 6.3 mg of trimethylamine borane was added, followed by stirring at 23° C. for 3 hours.

This was filtered and washed with 15 mL of a phosphate buffered saline (PBS, pH 7.4), 15 mL of a citrate buffer solution (pH 2.2), again 15 mL of PBS, 7.7 mL of a 50 mmol/L sodium hydroxide aqueous solution and 15 mL of distilled water, and 3.2 mL of a 0.1% acetic acid buffer solution (pH 5.2) containing 1% of benzyl alcohol was added to obtain a final product (Ex. 41) having protein A introduced. The immobilized amount of protein A was 11.5 mg/mL-bed. The elemental analysis values were C ratio: 5.57%, and N ratio: 0.56%.

The final product of affinity chromatographic carrier in Ex. 41 was packed to a glass column having an inner diameter of 5 mm×a length 50 mm, which was mounted on a chromatography apparatus “AKTA explorer 10S” (manufactured by GE Healthcare), whereupon PBS (pH 7.4) containing 0.5 mg/mL of polyclonal human IgG was passed through the column. The dynamic binding capacity was calculated by obtaining the mass of the added polyclonal human IgG, at the time when the absorbance of the eluate has leaked 10% to the absorbance of PBS (pH 7.4) containing 0.5 mg/mL of polyclonal human IgG passed through. The flow rate was 1.2 mL/min (residence time was set to be 0.82 min).

For the alkali resistance, DBC before and after immersion in a 500 mM sodium hydroxide aqueous solution at room temperature for a predetermined time, was compared, and the proportion of DBC after the immersion to DBC before the immersion was calculated. The value of DBC is shown in Table 5 and the value of relative DBC is shown in Table 6. In Ex. 41 of the present embodiment, it was found that high DBC was achieved even at a high flow rate, and alkali resistance was also high.

As a comparative example (Ex. 42), MabSelect SuRe LX (agarose carrier) manufactured by GE Healthcare, was used. Further, as a comparative example (Ex. 43), TOYOPEARL AF-rProtein A HC-650F (polymethacrylate carrier) manufactured by Tosoh Corporation, was used. However, the flow rate in Ex. 42 and Ex. 43 was set to be 0.5 mL/min (residence time was 1.96 min).

TABLE 5

| Immersion time | DBC (mg/mL-bed) | | |
|---|---|---|---|
| (min) | Ex. 41 | Ex. 42 | Ex. 43 |
| 0 | 53 | 30 | 57 |
| 400 | 50 | 30 | 43 |
| 600 | — | — | 36 |
| 800 | 47 | 25 | — |
| 1,200 | 39 | 26 | — |

TABLE 6

| Immersion time | Relative DBC (%) | | |
|---|---|---|---|
| (min) | Ex. 41 | Ex. 42 | Ex. 43 |
| 0 | 100 | 100 | 100 |
| 400 | 94 | 100 | 75 |
| 600 | — | — | 62 |
| 800 | 89 | 84 | — |
| 1,200 | 73 | 87 | — |

To 1 g of the diol-modified porous silica obtained in the same manner as in

Production Example 5, 15 mL of N,N-dimethylformamide, 76 mg of t-butoxy potassium (manufactured by Wako Pure Chemical Industries, Ltd.) and 82 mg of 1-bromobutane (manufactured by Wako Pure Chemical Industries, Ltd.) were added and stirred at room temperature for 4 hours. Then, the mixture was filtered, washed with 20 mL of methanol, 20 mL of a 50% aqueous methanol solution and methanol 20 mL, in this order, and dried at 70° C. for one day and night. Thus, a butyl group-modified porous silica (chromatographic carrier for reversed phase chromatography) was obtained.

### Ex. 45

To 5 g of the porous silica (A) obtained in Ex. 32, 22 mL of toluene, 0.85 mL of N,N-diisopropylethylamine and 1.08 mL of 3-glycidoxypropyltrimethoxysilane were added, followed by refluxing for 4.5 hours. After cooling, the mixture was filtered, washed by using 100 mL of toluene, 50 mL of tetrahydrofuran and 65 mL of methanol, in this order, and then dried at 70° C. for one day and night, to obtain an epoxy-modified porous silica.

To 0.3 g of the obtained epoxy-modified porous silica, 10 mL of an aqueous solution of 0.44 g of sodium bisulfite adjusted to pH 7 with 100 mM sodium hydroxide aqueous solution, was added and stirred at room temperature for 4 hours. Then, the mixture was filtered, washed with 20 mL of distilled water, after addition of 10 mL of a 10% aqueous sulfuric acid solution, immersed therein at room temperature for 1 hour, then washed by using 20 mL of distilled water and 20 mL of methanol, in this order, and dried at 70° C. for one day and night. Thus, a sulfonic acid-modified porous silica (chromatographic carrier for cation exchange chromatography) was obtained.

### Ex. 46

To 0.3 g of the epoxy-modified porous silica obtained in the same manner as in Ex. 45, 6 mL of tetrahydrofuran and 32 mg of anhydrous ethylenediamine (manufactured by Tokyo Chemical Industry Co., Ltd.) were added and stirred at room temperature for 4 hours. Then, the mixture was filtered, washed by using 20 mL of distilled water and 20 mL of methanol, in this order, and dried at 70° C. for one day and night. Thus, an amino group-modified porous silica (chromatographic carrier for anion exchange chromatography) was obtained.

### Ex. 47

To the amino group-modified porous silica obtained in Ex. 46, succinic anhydride was reacted in 1,4-dioxane to obtain a carboxy group-modified porous silica (chromatographic carrier for cation exchange chromatography).

This application is a continuation of PCT Application No. PCT/JP2016/061444, filed on Apr. 7, 2016, which is based upon and claims the benefit of priority from Japanese Patent Application No. 2015-080705 filed on Apr. 10, 2015. The contents of those applications are incorporated herein by reference in their entireties.

What is claimed is:

1. A porous silica comprising a phosphorus oxide component and a zirconium oxide component, wherein the amount of phosphorus atoms per unit specific surface area of the porous silica is from 1 μmol/m² to 25 μmol/m², and the amount of zirconium atoms per unit specific surface area of the porous silica is from 1 μmol/m² to 15 μmol/m².

2. A porous silica for chromatographic carrier, made of the porous silica as defined in claim 1.

3. The porous silica according to claim 2, wherein the number of theoretical plates obtainable by the following calculating formula from a peak detected by measurement of standard polystyrene with a molecular weight of 453 using a column packed with the porous silica, is at least 2,000 plates,
N=5.54×[t/W_{0.5}]²
where N is the number of theoretical plates, t is the retention time of the component, and W_{0.5} is the peak width at 50% position of the peak height.

4. A chromatographic carrier comprising the porous silica as defined in claim 1, and a ligand immobilized to the porous silica.

5. The chromatographic carrier according to claim 4, which is a chromatographic carrier for affinity chromatography, and the ligand contains protein A.

6. The chromatographic carrier according to claim 5, wherein the immobilized amount of Protein A is at least 9.5 mg/mL-bed.

7. The chromatographic carrier according to claim 5, wherein the dynamic binding capacity is at least 35 mg/mL-bed.

8. The chromatographic carrier according to claim 4, which is a chromatographic carrier for cation exchange chromatography wherein said ligand contains a sulfonic acid or carboxy group, a chromatographic carrier for anion exchange chromatography wherein said ligand contains an amine, a chromatographic carrier for reverse phase chromatography wherein the ligand contains an alkyl group, or a chromatographic carrier for size exclusion chromatography wherein the ligand contains a diol group.

9. A method for producing a porous silica, which comprises attaching a phosphorus oxide precursor and a zirconium oxide precursor in an optional order or simultaneously to a porous silica, followed by calcining.

10. The method for producing a porous silica according to claim 9, wherein the amount of phosphorus atoms per unit specific surface area of the obtainable porous silica is from 1 μmol/m² to 25 μmol/m², and the amount of zirconium atoms per unit specific surface area of the porous silica is from 1 μmol/m² to 15 μmol/m².

11. The method for producing a porous silica according to claim 9, wherein the phosphorus oxide precursor is attached to the porous silica, and then the zirconium oxide precursor is attached to the porous silica.

12. The method for producing a porous silica according to claim 9, wherein the phosphorus oxide precursor is phosphorus oxychloride, phosphoryl ethanolamine, potassium dihydrogen phosphate, dipotassium hydrogen phosphate, sodium dihydrogen phosphate, disodium hydrogen phosphate, a trialkyl phosphine, a triphenyl phosphine, a trialkyl phosphine oxide, a triphenyl phosphine oxide, a phosphoric acid ester, polyphosphoric acid or its salt, orthophosphoric acid or its salt, or phosphorus pentoxide.

13. The method for producing a porous silica according to claim 9, wherein the zirconium oxide precursor is zirconium (IV) chloride, zirconium (III) chloride, zirconium oxychloride, a tetraalkoxy zirconium, or a dialkoxy zirconium dichloride.

14. The method for producing a porous silica according to claim 9, wherein the phosphorus oxide precursor and the zirconium oxide precursor are attached to the porous silica by a dry method.

15. The method for producing a porous silica according to claim 9, wherein the temperature for the calcining is from 300° C. to 500° C.
